(19) United States
(12) Patent Application Publication
(10) Pub. No.: US 2017/0034008 A1
(43) Pub. Date: Feb. 2, 2017

(54) NETWORK MANAGEMENT USING PORT ANNOUNCEMENTS

(71) Applicant: HEWLETT PACKARD ENTERPRISE DEVELOPMENT LP, Houston, TX (US)

(72) Inventors: Krishna Puttagunta, Roseville, CA (US); Vivek Agarwal, Littleton, MA (US); Rupin T. Mohan, Littleton, MA (US); Navaruparajah Nadarajah, Roseville, CA (US); Andrew E.S. MacKay, Marlborough, MA (US); Derek James Manning, Marlborough, MA (US); Kyle Fransham, Marlborough, MA (US); Charles J. Newfell, JR., Littleton, MA (US)

(21) Appl. No.: 15/303,116

(22) PCT Filed: Apr. 29, 2014
(86) PCT No.: PCT/US2014/035805

§ 371 Date: Oct. 10, 2016

(51) Int. Cl. H04L 12/24

(52) U.S. Cl. CPC H04L 41/12; H04L 67/1097

(57) ABSTRACT

A system includes multiple devices in a storage area network (SAN). Each device includes at least one network port, at least one processor, and a management module. The management module is to receive announcements generated by ports included in an announcement group, where the ports are included in the other devices, and where each announcement includes port metadata for a particular port. The management module is also to determine, based on the announcements, a network mapping of the ports and the devices.

### BACKGROUND

A computing network can include any number of devices connected by data links. Some computing networks may be specialized to perform specific types of tasks. For example, a Storage Area Network (SAN) is generally configured to enable access to data storage devices such as disk arrays, tape libraries, jukeboxes, etc.

### BRIEF DESCRIPTION OF THE DRAWINGS

Some implementations are described with respect to the following figures.

FIG. 1 is a schematic diagram of an example network, in accordance with some implementations.

FIG. 2 is a schematic diagram of an example network device, in accordance with some implementations.

FIGS. 3A-3E are illustrations of a network mapping operation according to an example implementation.

FIG. 4 is allow diagram of a network mapping process according to some example implementations,

FIG. 5 is a flow diagram of a network mapping process according to sonic example implementations.

FIG. 6 is a flow diagram of a network management process according to some example implementations.

### DETAILED DESCRIPTION

Storage Area Networks (SANs) can include a variety of devices, and can utilize a variety of applications including. virtualization applications. In some examples, managing a SAN is a complex activity that is performed using specialized management applications and out-of-band data networks. Such example approaches may involve manual configurations at multiple places, and may thus be error-prone and time-consuming.

In accordance with some implementations, techniques or mechanisms are provided for network management using announcements (e.g., messages) generated by the ports of the network devices. Such announcements can be used to map ports and network devices, as well as their associated capabilities, services, etc. Further, such announcements can be used to enforce management policies in devices of the network.

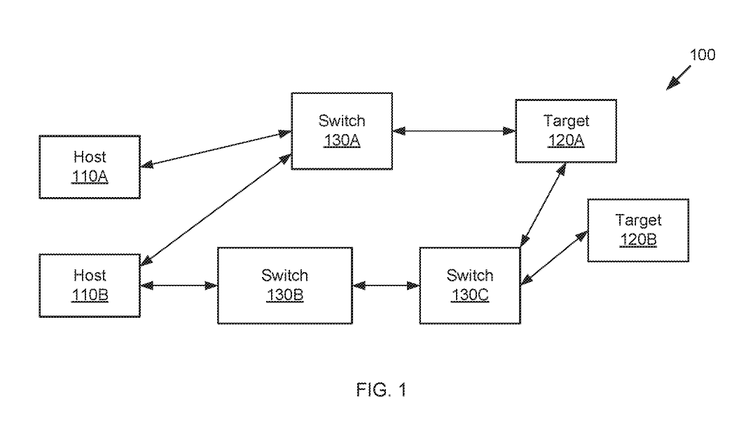

FIG. 1 is a schematic diagram of an example network 100, in accordance with some implementations. As shown, the network 100 can include any number and type of network devices, including hosts 110(A,B), targets 120(A,B), and/or switches 130(A,B,C). For example, target 120A may access host 110A, which can store data. Further, switch 130A may transfer data between endpoints, such as host 110A and target 120A. Such devices may be coupled by any number and configuration of interconnections.

The network 100 can be configured for a particular task or purpose. For example, in some implementations, the network 100 may be a Storage Area Network (SAN) including storage devices. In such implementations, the hosts 110(A,B) and/or the targets 120(A,B) may include, for example, disk arrays, tape libraries, optical jukeboxes, servers, etc.

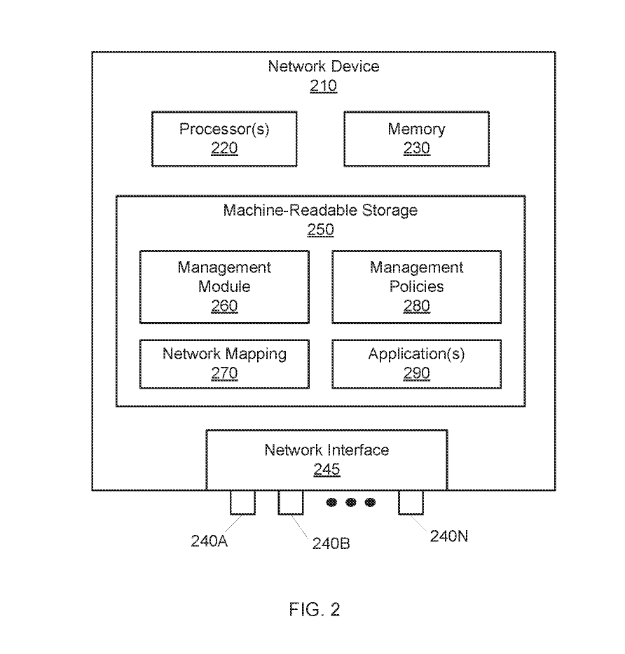

In accordance with some implementations, some or all of the devices of the network 100 may be configured to transmit announcements, and to receive announcements from other devices. Such announcements can be used to map devices and associated services of the network 100. Further, such announcements may be used to automatically enforce policies in the network. These features will be described further below with reference to FIGS. 2-6.

Referring now to FIG. 2, shown is a schematic diagram of an example network device 210, in accordance with some implementations. In some implementations, the network device 210 may correspond generally to any of the network devices shown in FIG. 1 (e.g., hosts 110(A,B), targets 120(A,B), switches 130(A,B,C), etc.). In other implementations, the network device 210 may be a management device, and may manage a group of other devices included in a network (e.g., network 100 shown in FIG. 1).

As shown, the network device 210 can include processor(s) 220, memory 230, machine-readable storage 250, and a network interface 245. The processor(s) 220 can include a microprocessor, microcontroller, processor module or subsystem, programmable integrated circuit, programmable gate array, multiple processors, a microprocessor including multiple processing cores, or another control or computing device. The memory 230 can be any type of computer memory e.g., dynamic random access memory (DRAM), static random-access memory (SRAM), etc.). The machine-readable storage 250 can include non-transitory storage media such as hard drives, flash storage, optical disks, etc.

In some implementations, the network interface 245 can include any number of ports 240(A-N). The ports 240(A-N) can provide “in-band” data transmission using the primary data interconnections between the network devices 210). In some implementations, the ports 240(A-N) can provide “out-of-band” data transmission (i.e., using a channel reserved for system management data). The network interface 245 can use any network standard or protocol (e.g., Ethernet, Fibre Channel, Fibre Channel over Ethernet (FCoE), Internet Small Computer System Interface (iSCSI), a wireless network standard or protocol, etc.).

As shown, the machine-readable storage 250 can include a management module 260, a network mapping 270, management policies 280, and application(s) 290. In some implementations, the management module 260 can send a request for the network device 210 to join an announcement group (i.e., a specified group of devices that are to send and receive announcements). For example, in sonic implementations, the management module 260 may send an Internet Group Management Protocol (IGMP) message to join a multicast group in which members are to receive announcements.

An example listing of a multicast announcement message is provided below:

```
message FSCHost {
  extensions 100 to max;
  enum Type {
  UNKNOWN = 0;
  ISCSI_TARGET = 1;
  ISCSI_INITIATOR = 2;
  SWITCH = 3;
  }
  message CustomFields {
  required string key = 1;
  required string value = 2;
  }
  required Type type = 1;
  required string ip_address = 2;
  optional string name = 3;
  optional string state = 4;
  optional string vendor = 5;
  optional string model = 6;
  repeated CustomFields custom_fields = 7;
}
```

After joining an announcement group, the management module 260 can automatically send announcements to members of the announcement group. Further, the announcements may be transmitted periodically, or according to a defined schedule, or in response to an event, etc. The announcements may be, for example, multicast packets, broadcast packets, and so forth. In addition, the announcements may be transmitted via in hand data connections (e.g., using primary data interconnections that are not dedicated to management data).

In some implementations, the management module 260 can receive other announcements from members of the announcement group. For example, in some implementations, the management module 260 can use IGMP snooping at layer 2 to optimize the flow of announcements only to ports that have joined a multicast group. In this manner, other ports that do not use the announcements will not be flooded by the announcements.

In some implementations, each announcement may be transmitted by a single port of the network device 210. Further, each announcement can include “port metadata,” which can refer to data describing the network device 210 and/or the transmitting port In some implementations, the port metadata can include attributes and/or capabilities of the network device 210 and/or the transmitting port. For example, an announcement transmitted by port 240B may include metadata describing attributes of network device 210 and/or port 240B (e.g., device identifier, port name, physical port address, Internet Protocol (IP) address, software version, manufacturer identifier, network zoning or partitioning, etc.). In another example, an announcement transmitted by port 240A may include metadata describing capabilities of network device 210 and/or port 240A (e.g., storage capacity, disk speed, redundancy, data transfer rates, error correction capabilities, Quality of Service capabilities, security/encryption capabilities, legal compliance, application services, protocol or API services, etc.).

In some implementations, the port metadata can describe services and/or applications associated with the transmitting port. For example, an announcement transmitted by port 240B may include metadata describing a service or application that is provisioned on (or assigned to) port 240B. Further, the port metadata can include logical address information (e.g., a Virtual Port, a Virtual Machine (VM), a Virtual Local Area Network (VLAN) identifier, a Logical Unit Number (LUN) identifier, etc.) associated with the transmitting port. For example, an announcement transmitted by port 240B may include metadata describing a VLAN and/or a LUN associated with a service or application provisioned on port 240B.

In some implementations, the management module 260 can build and update the network mapping 270 based on received announcements. The network mapping 270 may include a topology map of the connections between the ports 240(A-N) and/or network devices 210. Further, the network mapping 270 may include information about the attributes and/or capabilities associated with the ports 240(A-N) and/or network devices 210. In addition, the network mapping 270 may include information about “flows,” which can be the particular data paths between applications and/or services and their target devices.

In some implementations, the management module 260 can evaluate and execute the management policies 280 using announcements and/or the network mapping 270. By executing the management policies 280, each network device 210 can manage its own network configuration. Further, the management policies 280 may specify actions to enable an application or service to configure the network devices 210 which provide the flow of the application or service. For example, the management policies 280 may specify that an application is to be assigned to a storage device based on disk speed, encryption level, redundancy, etc. In another example, the management policies 280 may group devices into a zone. Further, in some implementations, the network device 210 may be a specialized management device, and may execute the management policies 280 to manage a group of other devices included in a network.

The network device 210 shown in FIG. 2 may be referred to as an “enabled device,” which can be a device that includes the network mapping and management features described herein (e.g., the features of the management module 260). Further, the term “non-enabled device” may refer to a device that does not include the network mapping and management features described herein.

In some implementations, the announcements may be formatted as standard multicast or broadcast messages that are automatically forwarded by non-enabled devices. For example, referring again to FIG. 1, assume that switch 130B is a non-enabled device, and that switch 130C is an enabled device. In this example, an announcement sent by the host 110B is received by the non-enabled switch 130B, and is then forwarded to the enabled switch 130C.

In some implementations, the management module 260 can update the network mapping 270 using information from non-enabled devices. For example, the management module 260 can use join requests from new members (e.g., an IGMP message) to notify a layer 3 protocol (e.g., Distance Vector Multicast Routing Protocol (DVMRP), Protocol-Independent Multicast (PIM), etc.). The layer 3 protocol can then build a short path tree between all receivers and senders of the group, including both enabled and non-enabled devices. This path tree information can be used to update the network mapping 270,

In some implementations, the management module 260 can include Application Programming Interfaces (API) for external management frameworks (e.g., Software Defined Networking (SDN) frameworks, OpenStack frameworks, etc.). Such APIs can enable external management systems to access the network mapping 270, and to manage network devices using the management policies 280.

Various tasks of the management module 260 are discussed further below with reference to FIGS. 2, 3A-3C, 4, and 5. Note that any of the tasks described herein in relation to the management module 260 can be implemented in any suitable manner. For example, any of these tasks can be hard-coded as circuitry included in the processor(s) 220 and/or the network device 210. In other examples, the management module 260 can be implemented as circuitry and/or machine-readable instructions included in the network interface 245.

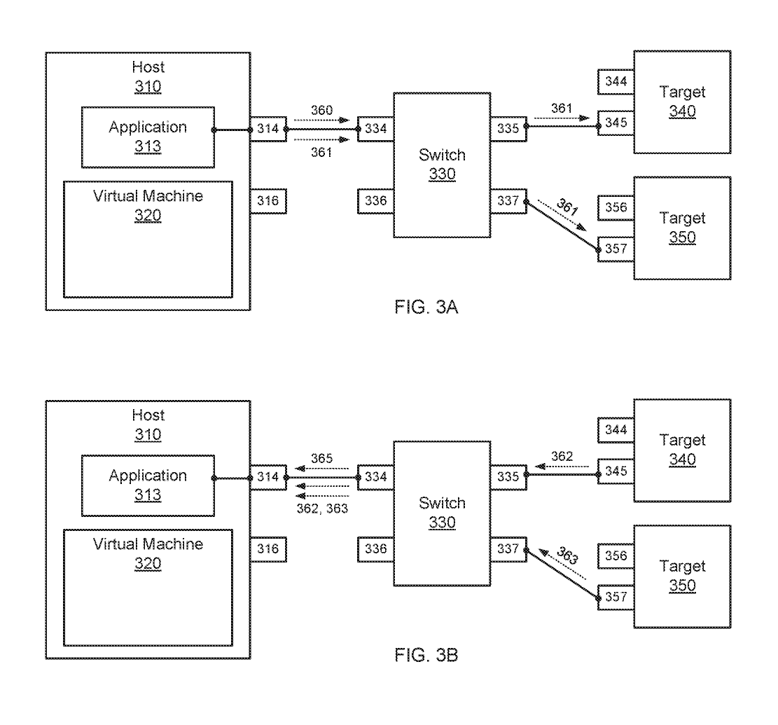

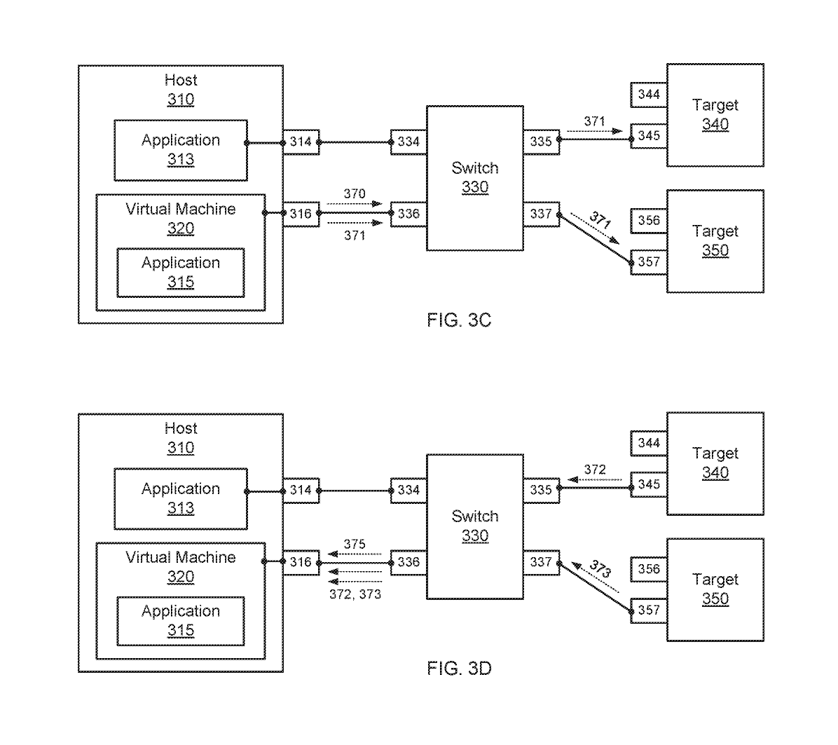

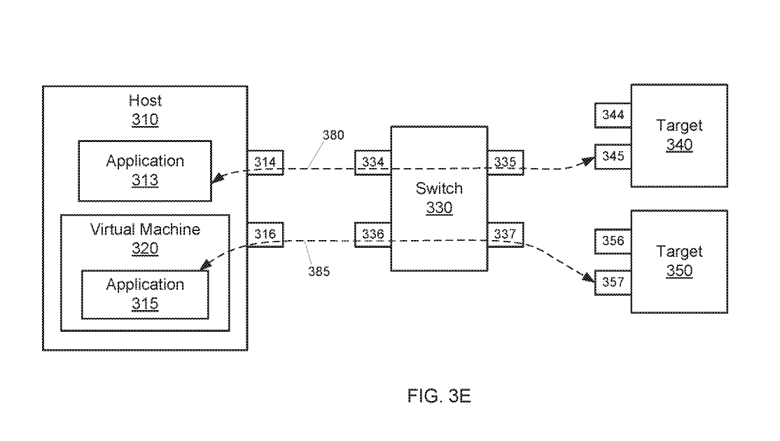

FIGS. 3A-3E are illustrations of an example network mapping operation according to some implementations. Specifically, FIGS. 3A-3E illustrate an example network mapping operation in a network including a host 310, a switch 330, a target 340, and a target 350. Any of the devices can correspond generally to the network device 210 shown in FIG. 2. Assume that, in an initial state of this example, port 335 of switch 330 is connected to port 345 of target 340, and that port 337 of switch 330 is connected to port 357 of target 350. Assume also that ports 334, 335, 337, 345, and 357 are included in an announcement group. Further, assume that ports 314, 316, 336, 344, and 356 are not included in the announcement group.

Referring now to FIG. 3A, assume that application 313 is provisioned to port 314 of host 310, and that port 314 is connected to port 334 of switch 330. As shown, port 314 may send a join request 360 to port 334. In some implementations, switch 330 may join port 314 to the announcement group in response to the join request 360.

After joining the announcement group, port 314 sends an announcement 361 to port 334. As shown, the announcement 361 is then forwarded to other members of the announcement group (e.g., ports 345 and 357). The announcement 361 may include metadata describing port 314, host 310, and/or application 313, in some implementations, switch 330, target 340, and target 350 can use the received announcements 361 to update their network mappings (e.g., network mapping 270 shown in FIG. 2) to include information about port 314, host 310, and/or application 313.

In some implementations, host 310 can also receive announcements from other members of the announcement group. For example, as shown in FIG. 3B, port 345 can send an announcement 362 including metadata describing port 345 and/or target 340. Similarly, port 357 can send an announcement 363 including metadata describing port 357 and/or target 350, The announcements 362 and 363 are received by switch 330, and are forwarded to host 310. Further, port 334 of switch 330 can also send an announcement 365 describing port 334 and/or switch 330. Host 310 can then use the received announcements 362, 363, and 365 to build or update a network mapping including switch 330, target 340, target 350, and their included ports. Note that, while not shown for the sake of clarity, other members of the announcement group (e.g., ports 335 and 337) can also send their own announcements to the announcement group.

Referring now to FIG. 3C, assume that assume that application 315 is loaded in a virtual machine 320 included in host 310. Assume further that application 315 is provisioned to port 316 of host 310, and that port 316 is connected to port 336 of switch 330. As shown, port 316 may send a join request 370 to port 336. In some implementations, switch 330 may join port 316 to the announcement group in response to the join request 370.

After joining the announcement group, port 316 sends an announcement 371 to port 336. The announcement 371 may be forwarded to other members of the announcement group (e.g., ports 345 and 357). The announcement 371 may include metadata describing port 316, host 310, virtual machine 320, and/or application 315. In sonic implementations, switch 330, target 340, and target 350 can use the received announcements 371 to update their network mappings to include information about port 316, host 310, virtual machine 320, and/or application 315. Further, as shown in FIG. 3D, host 310 can receive announcements 372, 373, and 375, and can then update its network mapping.

Referring now to FIG. 3E, assume that application 313 is provisioned to target 340, and application 315 is provisioned to target 350. In some implementations, a flow 380 between application 313 and target 340 may be determined from announcements generated by the ports included in the data path between application 313 and target 340 (e.g., announcements 361 and 362 shown in FIGS. 3A-3B). Similarly, a flow 385 between application 315 and target 350 may be determined from announcements generated by the ports included in the data path between application 315 and target 350 (e.g., announcements 371 and 372 shown in FIGS. 3C-3D).

In some implementations, the determination of flows 380 and 385 may be performed by any device including the network mapping features described herein (e.g., host 310, switch 330, target 340, and/or target 350). Further, each device can store information describing the flows 380 and 385 in its network mapping (e.g., network mapping 270 shown in FIG. 2). For example, the network mapping may identify each location along a flow, and may associate each location with a unique flow identifier.

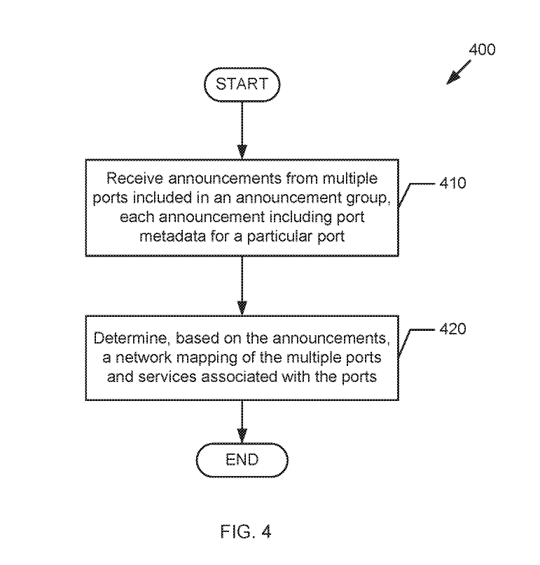

Referring now to FIG. 4, shown is a process 400 for network mapping in accordance with some implementations. The process 400 may be performed by the processor(s) 220 and/or the management module 260 shown in FIG. 2. The process 400 may be implemented in hardware or machine-readable instructions (e.g., software and/or firmware). The machine-readable instructions are stored in a non-transitory computer readable medium, such as an optical, semiconductor, or magnetic storage device. For the sake of illustration, details of the process 400 may be described below with reference to FIGS. 1, 2, and 3A-3E, which show examples in accordance with some implementations. However, other implementations are also possible.

At 410, announcements from multiple ports included in an announcement group may be received. Each announcement may include port metadata describing a particular port. For example, referring to FIG. 3B, port 314 of host 310 may receive announcements 362, 363, and 365. Each announcement can include metadata describing the port that generated the announcement, including attributes, capabilities, services, and/or applications associated with the port. In addition, each announcement can describe a device including the port.

At 420, a network mapping of the multiple ports and their associated services may be determined based on the received announcements. For example, referring to FIG. 3B, host 310 can use the received announcements 362, 363, and 365 to build or update a network mapping (e.g., network mapping 270 shown in FIG. 2) including ports 334, 345, and 357. The network mapping can also include services provided by ports 334, 345, and 357. Further, the network mapping can include switch 330, target 340, and target 350. After 420, the process 400 is completed.

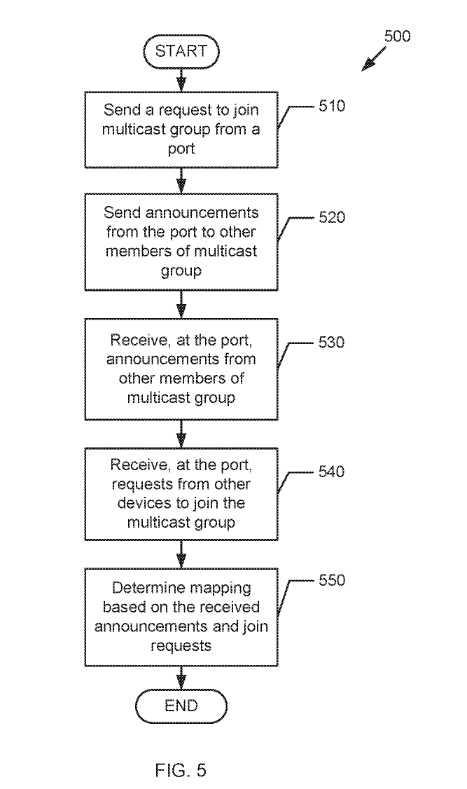

Referring now to FIG. 5, shown is a process 500 for network mapping in accordance with some implementations. The process 500 may be performed by the processor(s) 220 and/or the management module 260 shown in FIG. 2. The process 500 may be implemented in hardware or machine-readable instructions (e.g., software and/or firmware). The machine-readable instructions are stored in a non--transitory computer readable medium, such as an optical, semiconductor, or magnetic storage device. For the sake of illustration, details of the process 500 may be described below with reference to FIGS. 1, 2, and 3A-3E, which show examples in accordance with some implementations, However, other implementations are also possible.

At 510, a request to join a multicast group may be sent from a port. For example, referring to FIG. 3A, port 314 of host 310 sends the join request 360 to join a multicast group including ports 334, 335, 337, 345, and 357. In some implementations, the join request is an IGMP message. In response to the join request, a member of the multicast group (e.g., switch 330) may join the requesting port to the multicast group.

At 520, after joining the multicast group, announcements may be sent to other members of multicast group. For example, referring to FIG. 3A, port 314 of host 310 sends the announcement 361 to other members of the multicast group. In some implementations, the announcement 361 is a multicast message.

At 530, announcements from other members of the multicast group may be received at the port. For example, referring to FIG. 3B, port 314 of host 310 receives announcements 362, 363, and 365, including metadata describing ports 345, 357, and 334, respectively.

At 540, requests to join the multicast group may be received at the port from other devices. For example, referring to FIG. 3D, port 344 of target 340 may receive a IGMP from another device not shown) to join a multicast group.

At 550, a network mapping of the multiple ports and their capabilities may be determined based on the received announcements and join requests. For example, referring to FIG. 3C, target 340 can use announcement 371 to build or update a network mapping. In addition, target 340 can use received join requests to build a path tree, and can update the network mapping to include information from the path tree. After 550, the process 500 is completed.

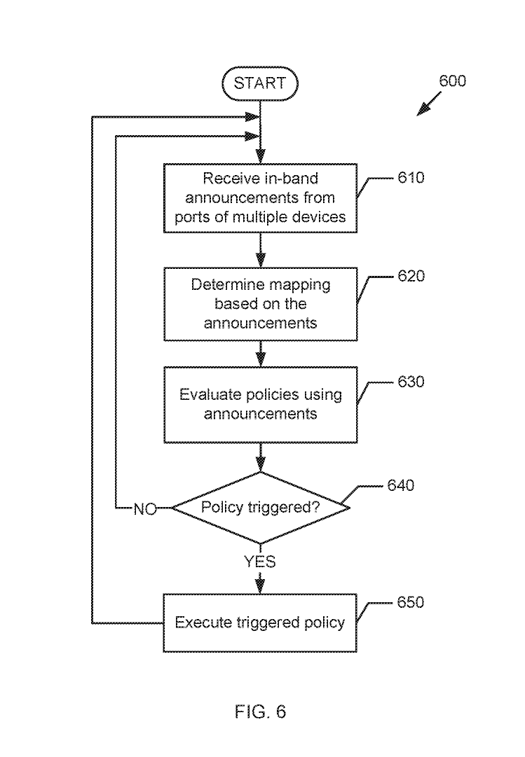

Referring now to FIG. 6, shown is a process 600 for network management in accordance with some implementations. The process 600 may be performed by the processor(s) 220 and/or the management module 260 shown in FIG. 2. The process 600 may be implemented in hardware or machine-readable instructions e.g., software and/or firmware). The machine-readable instructions are stored in a non-transitory computer readable medium, such as an optical, semiconductor, or magnetic storage device. For the sake of illustration, details of the process 600 may be described below with reference to FIGS. 1, 2, and 3A-3E, which show examples in accordance with some implementations. However. other implementations are also possible.

At 610, in-band announcements from multiple ports included in an announce e group may be received. For example, referring to FIG. 3B, port 314 may receive announcements 362, 363, and 365 via an in-band connection to port 334 of switch 330.

At 620, a network mapping of the multi pie ports and their capabilities may be determined based on the received announcements. For example, referring to FIG. 3B, the host 310 can use the received announcements 362, 363, and 365 to build or update a network mapping.

At 630, management policies may be evaluated using the announcements. In some implementations, the management policies can be evaluated using the network mapping. For example, referring to FIG. 2, the management module 260 may evaluate the management policies 280 using the announcements received via the network ports 240(A-N). In another example, the management module 260 can evaluate the management policies 280 using only the network mapping 270. In yet another example, the management module 260 can evaluate the management policies 280 using both the announcements and the network mapping 270.

At 640, a determination is made about whether a management policy is triggered by the announcements and/or the network mapping. For example, referring to FIG. 2, the management module 260 can determine whether any trigger conditions included in the management policies 280 are satisfied by the received announcements and/or the information or state of the network mapping 270.

If it is determined at 640 that a management policy is not triggered by the announcements and/or the network mapping, then the process 600 can repeat at 610. However, if it is determined at 640 that a management policy is triggered by the announcements and/or the network mapping, then at 650, the triggered management policy may be executed. For example, referring to the network device 210 shown in FIG. 2, the management module 260 and/or the processor(s) 220 can execute any management policies 280 that are triggered by received announcements and/or the information of the network mapping 270. Executing the management policies 280 can include, e.g., creating a VLAN, creating Fibre Channel zones, enforcing Quality of Service (QoS) specifications, implementing an Access Control List (ACL), checking for inconsistencies in network configuration or mapping information, performing audits, matching capabilities across a flow, etc. After 650, the process 600 can repeat at 610. The process 600 may enable individual network devices to manage the configuration of the network and its included flows.

In accordance with some implementations, the announcements described herein may enable individual devices to build and maintain network mapping information automatically using “push” communication, and without employing out-of-band “pull” communication. Further, the announcements can be used to enable “target orchestration,” which can refer to individual network devices automatically controlling and managing the configuration of the network and application flows. Furthermore, the announcements may be used to combine information from logical and physical domains in a single mapping. In addition, the announcements may enable network management while maintaining compatibility with non-enabled devices.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks other magnetic media including tape optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components, The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A system comprising:
a given device of a plurality of devices of a storage area network (SAN), wherein the given device comprises:
at least one network port;
at least one processor;
a management module executable on the at least one processor to:
receive, at the at least one network port, a plurality of announcements generated by a plurality of ports included in an announcement group, wherein the plurality of ports are included in other devices of the plurality of devices, wherein each announcement of the plurality of announcements includes port metadata for a particular port of the plurality of ports, and wherein the port metadata includes at least one of capability information application information, or information describing a service for a particular port of the plurality of ports; and
determine, based on the plurality of announcements, a network mapping of the plurality of ports and the plurality of devices.

2. The system of claim 1, the management module further to:
generate a request to join the at least one network port to the announcement group.

3. The system of claim 2, wherein the request is an Internet Group Management Protocol (IGMP) message.

4. The system of claim 1, wherein each of the plurality of announcements is selected from one of a multicast message and a broadcast message.

5. The system of claim 1, wherein the network mapping includes at least one physical address and at least one logical address.

6. (canceled)

7. The system of claim 1, the management module further to:
determine whether a management policy is triggered by at least one of the plurality of announcements; and
in response to a determination that the management policy is triggered, executing the management policy.

8. A method comprising:
receiving, with a device of a network, a plurality of announcements generated by a plurality of other devices of the network, wherein the plurality of other devices comprise a plurality of ports connected to a network, wherein each announcement of the plurality of announcements includes port metadata for a particular port of the plurality of ports, the port metadata describing at least one capability and at least one service associated with the particular port; and
determining, with the device and based on the plurality of announcements, a mapping of the plurality of ports and services associated with the plurality of ports.

9. The method of claim 8, wherein the plurality of announcements are automatically transmitted as in-band messages by the plurality of ports according to a repeating period or schedule.

10. The method of claim 8, wherein the plurality of ports are members of an announcement group.

11. The method of claim 10, further comprising:
prior to receiving a plurality of announcements, sending a request to join the announcement group.

12. The method of claim 8, wherein determining the mapping is further based on path tree information, wherein the path tree information describes both enabled and non-enabled devices connected by the network.

13. An article comprising at least one non-transitory machine-readable storage medium storing comprising instructions that upon execution cause a network device to:
transmit, from a first port of the network device, a request to join the first port to an announcement group, wherein the announcement group is a multicast group including a plurality of ports of other network devices; and
subsequent to joining the announcement group, transmit a periodic announcement from the first port, wherein the periodic announcement is an in-band multicast message including metadata describing capabilities and at least one application associated with the first port.

14. The article of claim 13, wherein the instructions further cause the network device to:
subsequent to joining the announcement group, receive a plurality of periodic announcements from the plurality of ports; and
determining a network mapping using the plurality of periodic announcements, the network mapping including capability and application information associated with the plurality of ports.

15. The article of claim 14, wherein the instructions further cause the network device to:
determine whether at least one management policy is triggered by at least one of the plurality of announcements; and
in response to a determination that the at least one management policy is triggered by at least one of the plurality of announcements, performing at least management action specified by the at least one management policy.
